(19) United States
(12) Patent Application Publication
(10) Pub. No.: US 2012/0091894 A1
(43) Pub. Date: Apr. 19, 2012

(54) LED DRIVING DEVICE

(76) Inventors: SHIH-JEN CHUANG, Xindian City (TW); Han-Chi Chang, Xindian City (TW); Chun-Yi Tsai, Xindian City (TW)

(21) Appl. No.: 12/903,218

(22) Filed: Oct. 13, 2010

(51) Int. Cl. F21V 29/00; H05B 37/02

(52) U.S. Cl. 315/112; 315/291

(57) ABSTRACT

An LED (Light-Emitting Diode) driving device is electrically connectable with an alternating current (AC) power supply and includes an electronic converter received in the driving device and a first connector, which is formed on an end of the driving device to connect with the AC power supply and in electrical connection with the electronic converter, and a second connector, which is formed on another end of the driving device for connection with an LED lighting module. When the first connector is set in electrical connection with the AC power supply, the above arrangement allows for conversion of electrical current and voltage to those applicable to an LED lighting module within 10 W rating.

### (a) TECHNICAL FIELD OF THE INVENTION

The present invention generally relates to a driving device, and more particularly to an LED (Light-Emitting Diode) driving device that allows for use with any type LED lighting module with a given range of power rating and that allows for replacement of a malfunctioning driving device without simultaneous replacement of a workable LED lighting module.

### (b) DESCRIPTION OF THE PRIOR ART

Energy crisis and environment pollution are significant challenges for the construction of hall tonic society and sustainable development. Development of new energy sources and renewable energies for energy saving and environmental protection are vital for the future development of the world. Taking an LED lamp as an example, the LED lamp features high brightness, long lifespan, compactness, and excellent reliability and also helps preserving environment. Thus, the LED lamps are popularly used for commercial lighting and household lighting. The application of LED lamps in semiconductor lighting provides prominent effects for energy saving and environmental conservation. Generally speaking, residence housing and workshops are replacing halogen lamps with LED lamps to reduce the total power consumption and expansion of time of lighting. However, the current commercially available LED lamps are quite expensive and among the components that compose the LED lamp, electrical components mounted on a circuit board contained in a base or connector of the lamp, such as electrolytic capacitors and low-voltage semiconductor devices, are of a shorter lifespan. Once the base or connector to which the LED lamp is mounted gets broken, the whole set of the LED lamp must be totally discarded, together with a heat dissipation device associated therewith. This means the LED lamp that still works must be discarded also. Apparently, this is a waster of resources and is not conservative for the environment. Further, for a regular LED lamp, the functions and color of light are generally not changeable. To change the function or light color, the LED lamp must be replaced. This is impractical and uneconomic. Further, discarding or incinerating the LED lamps causes severe contamination to the environment.

Further, the conventional device cannot be widely used with various sorts of LED lamp within a given power rating. In addition, the number and fashion of connection in series or in parallel of LED lamps are subjected to limitation.

### SUMMARY OF THE INVENTION

The primary objective of the present invention is to provide a driving device, which comprises an electronic converter that is received inside the driving device and a first connector, which is formed on an end of the driving device to be connectable with an AC power supply and is in electrical connection with the electronic converter and a second connector, which is formed on another end of the driving device for connection with an LED (Light-Emitting Diode) lighting module. The electronic converter comprises a power factor correction unit, a power conversion unit, and a power output control unit. With such an arrangement of the units, electrical power from an electric main can be converted into electrical current and voltage that can be applicable to any LED lighting module of 10W rating. When the first connector is set in connection with and receives an alternating current, the power factor correction unit functions to reduce the load voltage thereof, the power conversion unit converts the alternating current into a direct current applicable to the LED lighting module, and the power output control unit supplies the direct current to the LED lighting module for operation. As such, when the driving device malfunctions, a user may first detach the LED lighting module first for subsequently removing the malfunctioning driving device, and then the LED lighting module can be re-mounted to a new replacement driving device. With such a measure, the problem that a conventional LED lamp and an associated heat dissipation device must be completely discarded once the connector or base that connects the LED lamp malfunctions, which means the LED lamp that still works is also discarded, causing an undesired waste, can be overcome. Thus, a practical improvement that any type of LED lighting modules within a given power rating can be used with the driving device and that it only needs to replace a malfunctioning driving device, but not the LED lighting module, can be realized with the present invention.

A secondary objective of the present invention is to provide a driving device, which further comprises a brightness adjustment unit. The brightness adjustment unit is electrically connected with the power conversion unit With the arrangement of the brightness adjustment unit, the brightness of the LED lighting module can be adjusted. With such an arrangement, the drawback that the conventional LED lamp is not capable of brightness adjustment and that to change brightness requires replacement of the LED lamp, which make the conventional LED lamp impractical and uneconomic, and which may lead to environment contamination due to discarding or incineration of the LED lamp, can be overcome. Thus, a practical improvement that the brightness of a light source of LED lighting module can be adjusted through a brightness adjustment unit is realized with the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment according to the present invention.

FIG. 2 is a block diagram of the preferred embodiment of the present invention.

FIG. 3 is an exploded view of the preferred embodiment of the present invention.

FIG. 4 shows another embodiment according to the present invention.

FIG. 5 shows a further embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

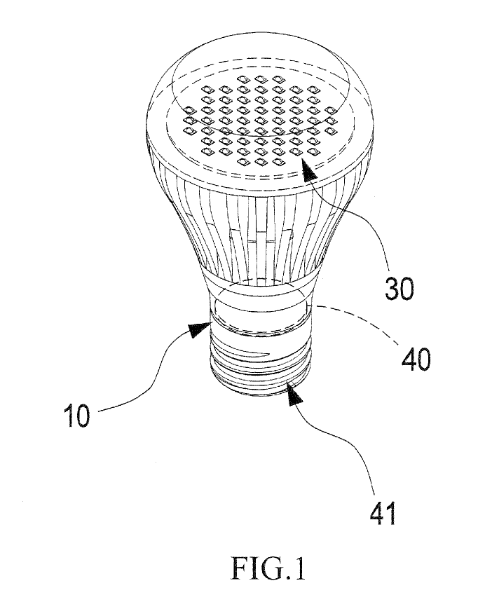

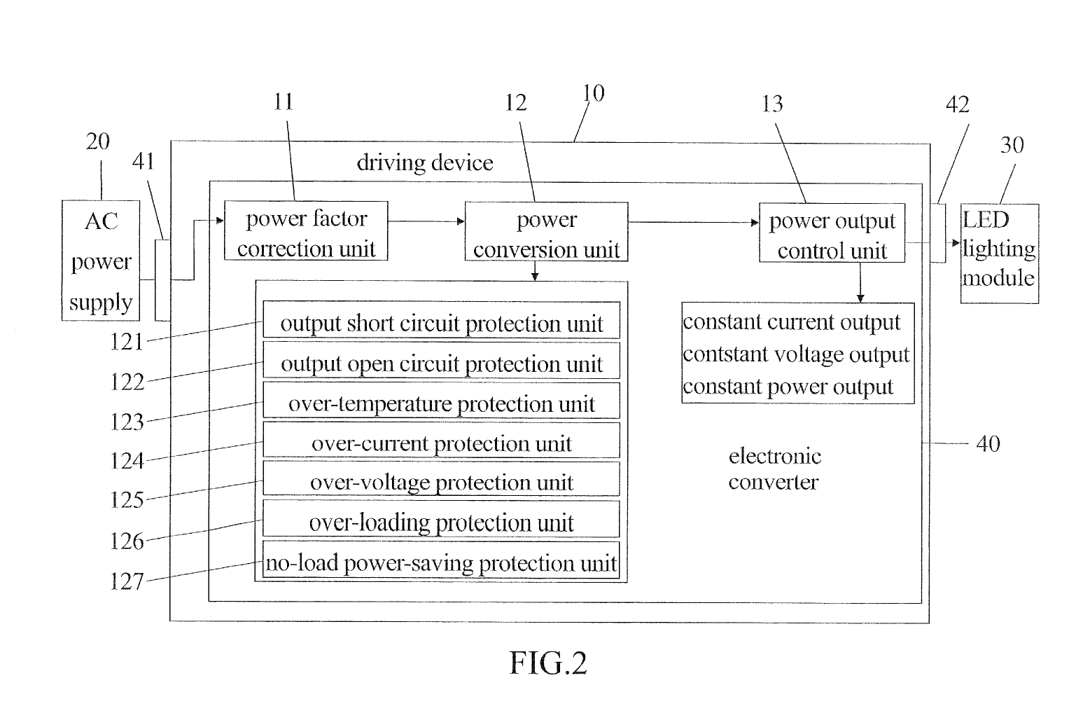

Referring to FIGS. 1 and 2, which show a perspective view and a block diagram of a preferred embodiment according to the present invention, respectively, the present invention provides a driving device, generally designated at 10, which is selectively set in electrical connection with an AC power supply. The driving device comprises a first connector and a second connector, which will be described hereinafter and are of any styles of standard indoor bulb base, socket, or connector, or any non-standard base, socket, or connector.

The driving device 10 according to the present invention generally comprises an electronic converter 40 that is received inside the driving device 10; and a first connector 41, which is formed on an end of the driving device 10 to be connectable with an AC power supply 20 and is in electrical connection with the electronic converter 40, and a second connector 4, which is formed on another end of the driving device 10 for connection with an LED (Light-Emitting Diode) lighting module 30 and is in electrical connection with the electronic converter 40.

The electronic converter 40 comprises a power factor correction unit 11 for changing load voltage, the power factor correction unit 11 being in electrical connection with the AC power supply 20; a power conversion unit 12 for conversion of type of power, the power conversion unit 12 being in electrical connection with the power factor correction unit 11, the power conversion unit 12 comprising an output short-circuit protection unit 121, an output open-circuit protection unit 122, an over-temperature protection unit 123, an over-current protection unit 124, an over-voltage protection unit 125, an over-loading protection unit 126, and a no-load power-saving protection unit 127; and a power output control unit 13 for stabilized output of electronic parameters, the power output control unit 13 being in electrical connection with the power conversion unit 12, the power output control unit 13 being for connection with the LED lighting module 30, which comprises at least one light-emitting diode 31 (LED) and at least one heat dissipation device 32, the electronic parameters being electrical current, electrical voltage, or power.

Further, the first connector 41 that is connectable with an AC power supply can be of any indoor used male-type configuration of bulb connector available in the market, including E27, E26, E14, E11, GU20, GU10, G24, G23, and B22, while the second connector 42 that is for connection with LED lighting module 30 can be of any male-type configuration available in the market, including MR16, MR11, AR111, PAR38, PAR36, PAR30, GU10, and JCG4.

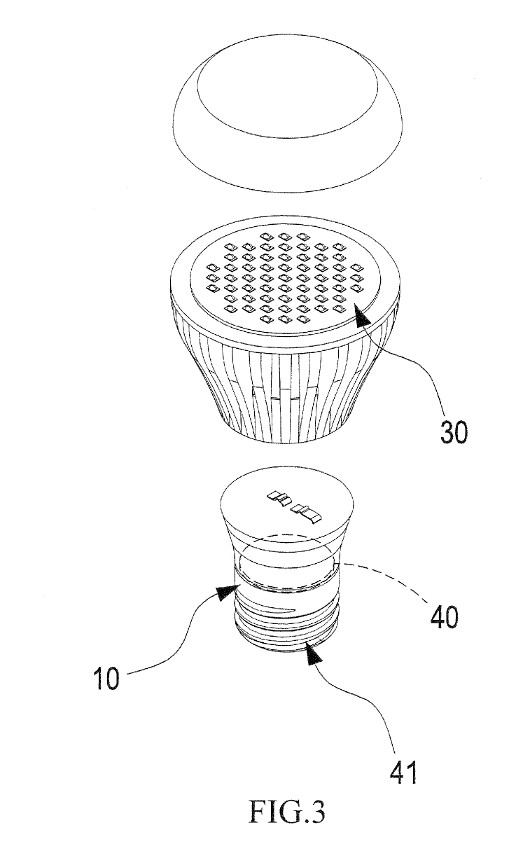

Also referring to FIGS. 2 and 3, which show a block diagram and an exploded view of the preferred embodiment of the present invention, respectively, with the above mentioned structure and arrangement, the driving device 10 receives electrical power from the AC power supply 20, and then the power factor correction unit 11 changes the load voltage and the power conversion unit 12 carry out conversion between alternating current and direct current and protections in respect of short circuit, open circuit, over temperature, over current, over voltage, over loading, and no-load power saving are also performed. The power output control unit 13 then supplies stabilized voltage, current, and power to activate an LED lighting module 30 within 10 W rating. As shown in FIG. 3, when the driving device 10 malfunctions, a user needs only to detach the driving device 10 and the LED lighting module 30 for replacement of the driving device 10 without replacing the LED lighting module 30, which is kept for subsequent use.

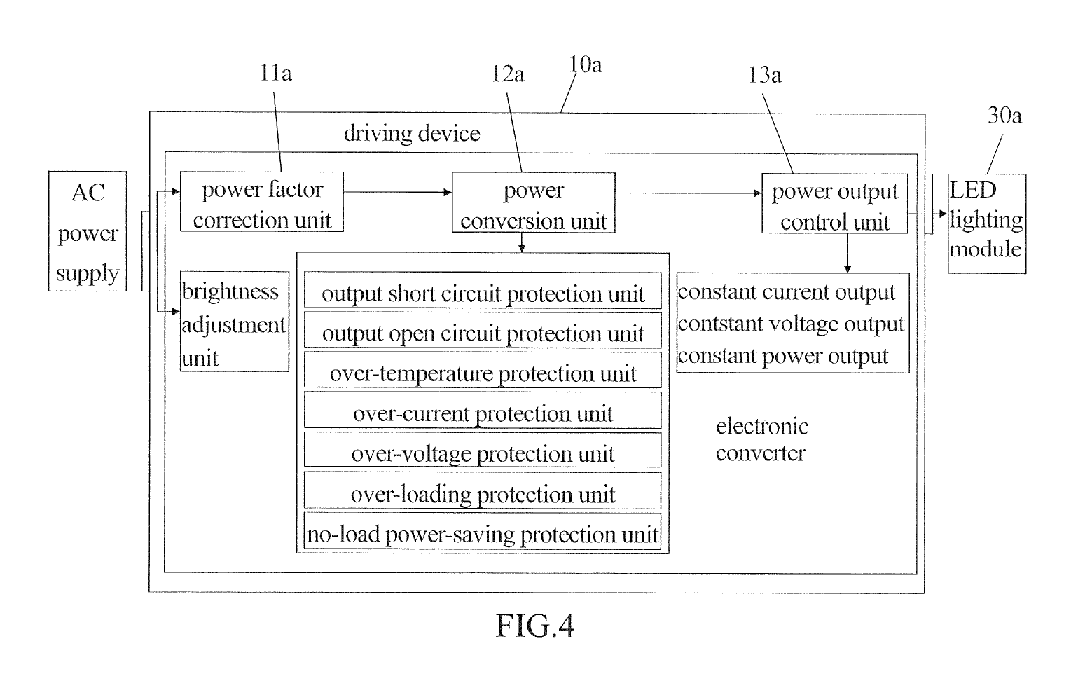

Referring to FIG. 4, which shows another embodiment according to the present invention, the driving device 10a of said another embodiment comprises a power factor correction unit 11a, a power conversion unit 12a in electrical connection with the power factor correction unit 11a, and a power output control unit 13a in electrical connection with the power conversion unit 12a. The driving device 10a further comprises a brightness adjustment unit 14a, which is electrically connected to the power conversion unit 12a. The brightness adjustment unit 14a provides a function of brightness adjustment for an LED lighting module 30a.

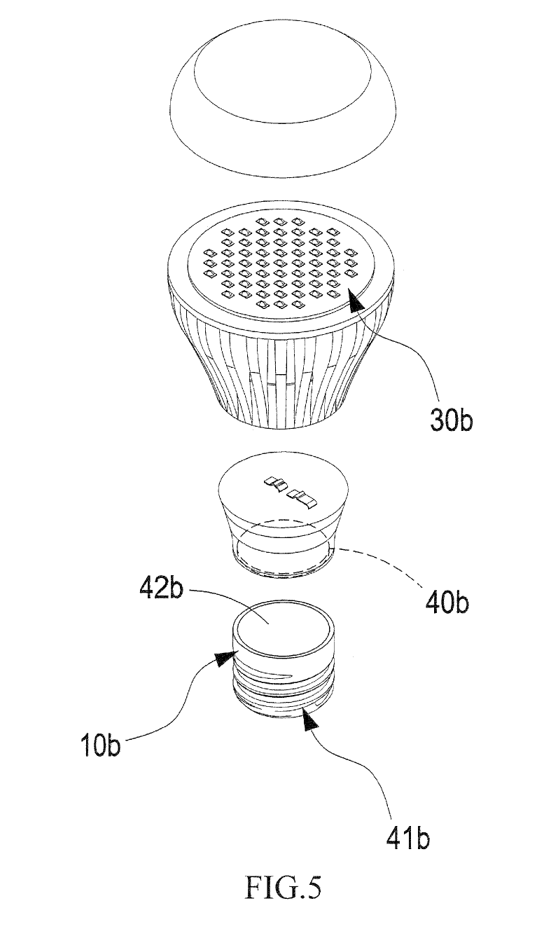

Referring to FIG. 5, which shows a further embodiment according to the present invention, the driving device 10b of said further embodiment is electrically connectable with an AC power supply and is for connection with an LED lighting module 30b. The driving device 10b receives therein an electronic converter 40b, which has an end in electrical connection with a first connector 41b that can be mounted by a user, and another end in electrical connection with the a second connector 42b to which an LED lighting module 30b can be mounted by the user. The second connector 42b is in electrical connection with the electronic converter 40b. With this arrangement, the first connector 41b, the driving device 10b, and the second connector 42b can be mounted/removed individually.

To summarize, the present invention provides the following advantages:

(1) When the driving device 10 malfunctions or is broken, a user can immediately replace a new driving device 10 by himself or herself without assistance or service provided by experts or skilled persons.

(2) There is no need to replace the LED lighting module 30, which can be kept for subsequent use, so that discarding the whole lighting device can be avoided.

(3) Any LED lighting module 30 within 10 W rating can be operated with the driving device 10 and any combination can be done by a user himself or herself, providing versatility of use.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light-emitting diode (LED) driving device, which is adapted to electrically connect to an AC power supply and receives an LED lighting module connected thereto, the LED driving device comprising:
an electronic converter, which is received in the driving device; and
a first connector, which is formed on an end of the driving device to connect with the AC power supply and in electrical connection with the electronic converter, and a second connector, which is formed on another end of the driving device for connection with the LED lighting module and in electrical connection with the electronic converter.

2. The LED driving device according to claim 1, wherein the electronic converter comprises:
a power factor correction unit for changing load voltage, the power factor correction unit being in electrical connection with the AC power supply;
a power conversion unit for conversion of type of power, the power conversion unit being in electrical connection with the power factor correction unit; and
a power output control unit for stabilized output of an electronic parameter, the power output control unit being in electrical connection with the power conversion unit, the power output control unit being for connection with the LED lighting module

3. The LED driving device according to claim 1, wherein the driving device comprises a brightness adjustment unit.

4. The LED driving device according to claim 1, wherein the first connector and the second connector are of a style of standard indoor bulb base, socket, or connector, or a non-standard base, socket, or connector.

5. The LED driving device according to claim 1, wherein the first connector is a regular bulb connector of E27, E26, E14, E11, GU20, GU10, G24, G23, or B22.

6. The LED driving device according to claim 1, wherein the LED lighting module comprises at least one light-emitting diode and at least one heat dissipation device.

7. The LED driving device according to claim 1, wherein the second connector is a regular bulb connector of MR16, MR11, AR111, PAR38, PAR36, PAR30, GU10, or JCG4.

8. The LED driving device according to claim 2, wherein the electronic parameter is electrical current, electrical voltage, or power.

9. The LED driving device according to claim 2, wherein the power conversion unit comprises an output short-circuit protection unit, an output open-circuit protection unit, an over-temperature protection unit, an over-current protection unit, an over-voltage protection unit, an over-loading protection unit, and a no-load power-saving protection unit.

10. The LED driving device according to claim 1, wherein the LED lighting module comprises an LED lighting module within 10 W rating.

11. A light-emitting diode (LED) driving device, which is adapted to electrically connect to an AC power supply and receives an LED lighting module connected thereto, the LED driving device comprising:
an electronic converter, which is received in the driving device;
a first connector, which is provided on an end of the driving device to connect with the AC power supply; and
a second connector, which is formed on another end of the driving device and in electrical connection with the electronic converter and is for connection with the LED lighting module.

12. The LED driving device according to claim 11, wherein the first connector is detachable from the driving device.
